(19) United States
(12) Patent Application Publication
(10) Pub. No.: US 2012/0073181 A1
(43) Pub. Date: Mar. 29, 2012

(54) WATERFOWL DECOY WEIGHT ASSEMBLY

(76) Inventors: Justin Loidolt, Elk River, MN (US); Brett Wilson, Ketchum, ID (US); Andrew Volkenant, Maple Plain, MN (US)

(21) Appl. No.: 13/237,603

(22) Filed: Sep. 20, 2011

Related U.S. Application Data
(60) Provisional application No. 61/384,510, filed on Sep. 20, 2010.

(51) Int. Cl. A01M 31/06; B23P 11/00

(52) U.S. Cl. 43/3; 29/428

(57) ABSTRACT

In one example, the disclosure relates to a waterfowl decoy weight assembly comprising a weight including a tether attachment structure configured to attach to a tether of a floatable waterfowl decoy; and an elastic cord including first and second end portions, wherein the first and second end portions are attached to the weight at one or more locations to form a loop. In such an example, the weight assembly may allow for a tether wrapped around a decoy body to be secured by placing the loop formed by the elastic cord over the decoy body such that the tension keeps the tether in place and secure during transport.

This application claims the benefit of U.S. Provisional Application No. 61/384,510, filed Sep. 20, 2010, the entire content of which is incorporated herein by reference.

### TECHNICAL FIELD

The disclosure generally relates to weight assemblies for securing floatable waterfowl decoys.

### BACKGROUND

In some instances, waterfowl hunters may use floatable waterfowl decoys when hunting waterfowl over water, such as, a slew, lake, pond, or river. The waterfowl decoys may float on the water surface to mimic the presence of waterfowl at the location being hunted. To anchor a waterfowl decoy in place while floating in the water, the decoy body may be connected to weigh located on the bottom of the body of water via a tether.

### SUMMARY

In general, the disclosure relates to waterfowl decoy weight assemblies. In some examples, a waterfowl decoy weight assembly may include a weight and an elastic cord coupled to the weight on two end portions to form a loop with the cord. The weight may also be attached to one end of a tether with the other end of the tether connected to a floatable waterfowl decoy. The weight may be positioned on the bottom of a body of water anchor the waterfowl decoy via the tether when the waterfowl decoy is floating in water.

When the waterfowl decoy is being stored or otherwise not in use, e.g., during transportation in a decoy bag, the tether may be wrapped around a portion of the waterfowl decoy to gather the length of the tether. While the tether is wrapped around the waterfowl decoy, the looped elastic cord coupled to the weight may be stretched by a user over a portion of the waterfowl decoy. When released, the elastic cord loop may be biased against the portion of the waterfowl decoy to secure the wrapped tether around the decoy body. In such a configuration, the tether may be prevented from coming unwrapped from the decoy and tangled, e.g., during transport of the waterfowl decoy.

In one embodiment, the disclosure relates to a waterfowl decoy weight assembly comprising a weight including a tether attachment structure configured to attach to a tether of a floatable waterfowl decoy; and an elastic cord including first and second end portions, wherein the first and second end portions are attached to the weight at one or more locations to form a loop.

In another example, the disclosure relates to a waterfowl decoy system comprising a floatable waterfowl decoy; a tether; and a decoy weight assembly, wherein the decoy weight assembly comprises a weight; and an elastic cord including first and second end portions, wherein the first and second end portions are attached to the weight at one or more locations to form a loop, wherein the tether is coupled to the floatable waterfowl decoy and is coupled the weight.

In another example, the disclosure relates to a method of making a waterfowl decoy weight assembly, the method comprising attaching first and second end portions of an elastic cord to a weight to form a loop, wherein the weight includes a tether attachment structure configured to attach to a tether of a floatable waterfowl decoy

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a conceptual diagram illustrating an example waterfowl decoy system including an example decoy weight assembly.

FIG. 2 is a conceptual diagram illustrating an example decoy weight assembly.

FIG. 3 is a conceptual diagram illustrating an example decoy weight of an example decoy weight assembly.

FIGS. 4-6 are conceptual diagrams illustrating various example configurations in which an example decoy weight is secured to an example waterfowl decoy via an example elastic cord.

### DETAILED DESCRIPTION

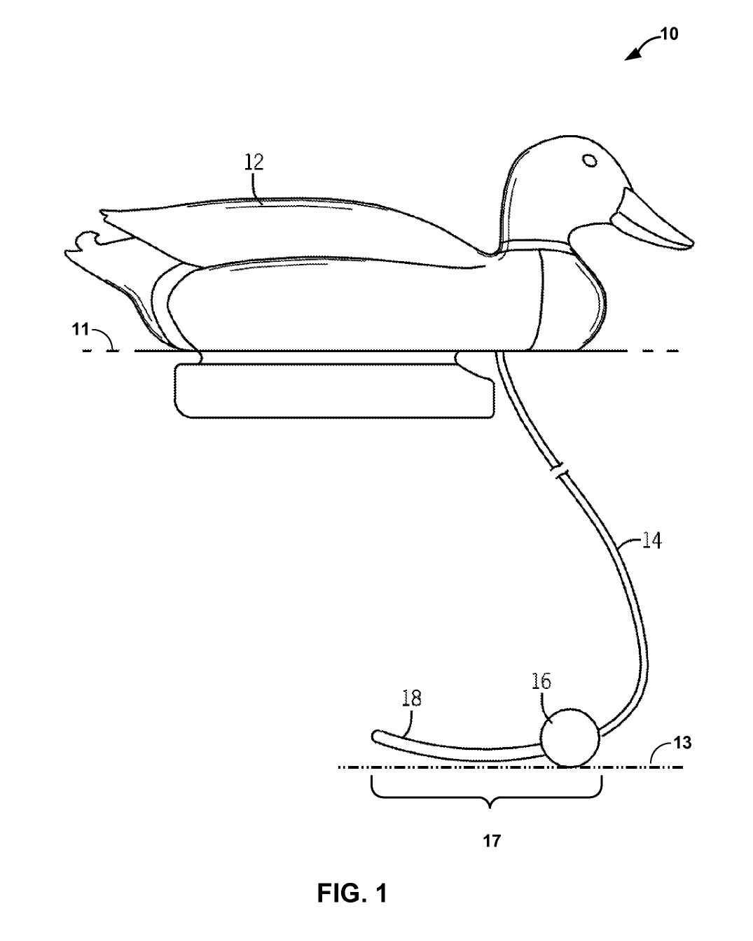

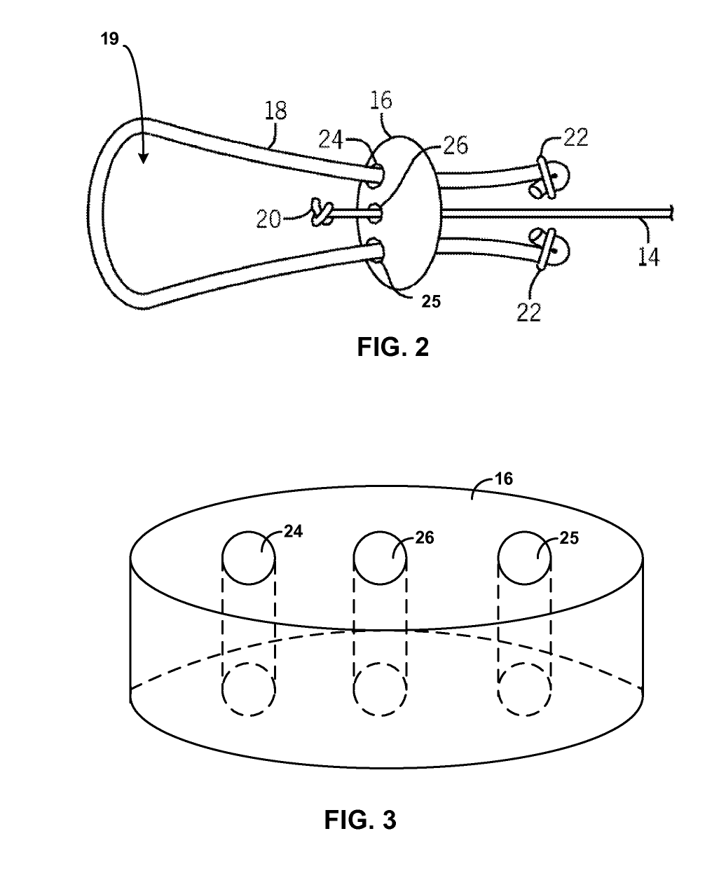

FIG. 1 is a conceptual diagram illustrating example waterfowl decoy system 10. Waterfowl decoy system 10 includes waterfowl decoy 12 and waterfowl decoy weight assembly 17. Water fowl decoy weight assembly 17 includes weight 16 and elastic cord 18, and is connected to waterfowl decoy 12 via tether 14. As will be described further with reference to FIG. 2, elastic cord 18 may be attached to weight 16 to form loop 19.

In the example shown in FIG. 1, waterfowl decoy 12 floats on surface 11 of a body of water, such, as, e.g., a slew, pond, lake, or river, to attract waterfowl to the area of water. Waterfowl decoy 12 may be any suitable type of decoy that may float on surface 11 of water. In some examples, decoy 12 may take for the form of a goose decoy and/or duck decoy. When waterfowl decoy 12 is floating on surface 11 of the body of water, weight 16 may be positioned on bottom 13 of a body of water anchor waterfowl decoy 12 via the tether 14. In this manner, decoy weight assembly 17 may keep waterfowl decoy 12 in substantially the same location in the water and prevent waterfowl decoy 12 from floating away from the location. Such a configuration may be similar to that of a boat anchor used to keep a boat in one location in the water but on a smaller scale.

In some instances, when hunting on water, a hunter has numerous waterfowl decoys placed in the water to attract waterfowl that is being hunted. Again, when the hunter throws a waterfowl decoy into the water, the weight keeps the decoy from moving down river, around the lake, and so forth. Once the hunter is done hunting for the day, he/she generally wraps the decoy tether back up around the decoy. For example, the decoy tether may be wrapped around the body or the keel of the waterfowl decoy. Usually, a large number of decoys are carried in one decoy bag for ease of transport and storage. If a decoy tether comes loose in the bag during transport, the tether can create knots, tangles, and general hassle for a hunter.

As will be described further below, decoy weight assembly 17 may be used to secure tether 14 to waterfowl decoy 12 after being wrapped about a portion of decoy 12, e.g., when waterfowl decoy 12 is being stored or during transportation in a decoy bag. Such a configuration is shown in FIGS. 4-6. As will be described further below, while tether 14 is wrapped around waterfowl decoy 12, looped elastic cord 18 coupled to weight 16 may be stretched by a user over a portion of waterfowl decoy 12. When released, elastic cord loop 19 may be biased against the portion of waterfowl decoy 12 to secure wrapped tether 14 around the decoy body. In such a configuration, tether 14 may be prevented from coming unwrapped from decoy 12 and tangled, e.g., during transport of the waterfowl decoy in a decoy bag. In some examples, decoy weight assembly 17 may allow one to wrap tether 14 around a portion of waterfowl decoy 12, e.g., the body, head, tail, and/or the keel, and then place elastic cord loop 19 around a portion of waterfowl decoy 12. In such an example, the tension created from pulling the elastic cord 18 around the body, head, tail, and/or keel of decoy 12 may keep the decoy tether 14 wrapped and in place to secure during storage and transport, e.g., to and from a waterfowl hunting location.

FIG. 2 is a conceptual diagram illustrating decoy weight assembly 17 shown in FIG. 1. FIG. 3 is a conceptual diagram illustrating decoy weight 16 of decoy weight assembly 17 without elastic cord 18. As illustrated in FIG. 2, waterfowl decoy weight assembly 17 includes weight 16 and elastic cord 18 with two end portions coupled to weight 16 to form loop 19. An end of tether 14 is also coupled to weight 16 with the other end coupled to floatable waterfowl decoy 12.

Weight 16 may have any suitable shape, size, and material. Although weight 16 is shown in FIGS. 2 and 3 as having an egg shape or oval cross-section, other shapes are contemplated. For example, weight 16 may have a substantially square, trapezoidal, circular, or polygonal cross-section. In some examples, weight 16 may be substantially spherical or cubic.

In general, weight 16 may have a mass (or weight) that is sufficient to anchor waterfowl decoy 12 when floating, and may depend on the size of decoy 12 as well as the conditions when decoy 12 is deployed, e.g., wind, water current, and the like. Additionally, in some instances, it may be desirable to keep the overall mass of weight 16 below some threshold amount since, e.g., waterfowl decoy weight assembly 17 generally is carried by a user, particularly is relatively large numbers, in a decoy bag as well as decrease the bulk of the decoy weight assembly.

In some examples, weight 16 may have a mass of at least approximately 1 ounces (oz) or at least approximately 2 oz, such as, e.g., at least approximately 4 oz or at least approximately 8 oz. In some examples, weight 16 may have a mass of approximately 4 oz or approximately 8 oz. In some examples, weight 16 may have a mass less than approximately 20 oz. less than approximately 16 oz. In some examples, weight 16 may have a mass between approximately 1 oz and 20 oz, such as, e.g., between approximately 3 oz and approximately 8 oz.

Weight 16 may be formed on a material with relatively high density to reduce the overall size of weight 16. In some examples, weight 16 may be formed of lead. The use of lead to form weight 16 may be useful in that lead may be melted and poured into mold to form a desired shaped. Other materials suitable for such a process may also be used to form weight 16. In some examples, weight 16 may comprise, consist, or consist essentially of plastic or other polymer (e.g., high-density plastic, such as, high density polyethylene (HDPE)), a metal-plastic combination (e.g., a plurality of metal pieces held together with a plastic or other polymer binder), tungsten (W), steel, Au, Ag, Pt, Fe, Ni, Zn, Sn, Cu, and bronze.

Weight 16 may have a shape that allows first and second portions of elastic cord 18 to be attached to weight 16 to form loop 19. For example, in the example shown in FIGS. 2 and 3, weight 16 includes first aperture 24 and second aperture 25. In such a configuration, a first end portion of elastic cord 18 may extend through first aperture 24 and second end portion of elastic cord 18 may extend through second aperture 25. As shown, each end portion of elastic cord 18 may be folded over and crimped via a metal crimp (e.g., hog ring) to prevent the respective portions of cord 18 from being pulled back through weight 16. Additionally or alternatively, when folded, the folded portion of elastic cord 18 may be melted to secure the fold. In each example, tension may be applied by loop 19 without elastic cord becoming detached from weight 16. In addition or as an alternative to crimping cord 18 as shown in FIG. 2, respective end portion may be knotted to prevent the respective portions of cord 18 from being pulled back through weight 16. As another example, respective end portions of elastic cord 18 may be tied to each other when extending through first and second apertures 24, 25 to be attached to weight 16 and form loop 19. Other examples configurations are contemplated.

Additionally or alternatively, weight 16 may include one or more features for attaching elastic cord 18 to weight 16. For example, weight 16 may include one or more protrusions that provide a point for cord 18 to be tied to weight 16. In one example, such protrusions may include one or more eyelets for tying-off one or more ends of elastic cord 18 for attachment to weight 16 and to form loop 19. In some examples, such protrusions may include “T” shaped pins extending from the outer surface of weight to provide points for tying-off one or more ends of elastic cord 18 for attachment to weight 16 and to form loop 19. Other examples configurations are contemplated.

Additionally, weight 16 may have a shape that allows for an end portion of tether 14 to be attached to weight 16 while the other end of tether 14 is attached to decoy 12. Such a structure may be referred to as a tether attachment structure. In the example of FIGS. 2 and 3, weigh 16 includes third aperture 26. In such an example, an end portion of tether 14 may be inserted through aperture 26 and then tied off to be attached to weight 16. In the example shown in FIG. 2, tether 14 is tied to form knot 20 that prevent the end of tether from being pulled through third aperture 26. Additionally or alternatively, weight 16 may include one or more protrusions that provide a point for tether 14 to be tied to weight 16. For example, similar to that described above, the one or more protrusions may take the form of an eyelet or “T” shaped pins extending from the outer surface of weight 16 to provide points for tying-off an end portion of tether 14 for attachment to weight 16. Other examples configurations are contemplated.

Elastic cord 18 may be formed of any elastic material such that it may return to substantially the same size after being stretched. In this manner, as described above, loop 19 formed by elastic cord 18 may be stretched over a portion of decoy 12 when tether 14 is wrapped over a portion of decoy 12 and then provide tension against decoy 12 to secure tether 14 in the wrapped configuration. In some examples, elastic cord 18 may be formed of a bungee cord, which may comprise one or more elastic strands that form a core covered, e.g., with woven cotton or polypropylene sheath. In some examples, elastic cord 18 may comprise a plurality of rubber bands wound underneath a nylon cord cover.

Elastic cord 18 may have any suitable length and diameter to allow decoy weight assembly 17 to function as described herein. In some examples, the length of elastic cord 18, which may define the size of loop 19, may depend to some extent on the size of decoy 12, e.g., such that loop 19 may be stretched over a portion of decoy 19 and released to secure tether 14 in a wrapped configuration. In some examples, elastic cord 18 may be between approximately 4 inches and approximately 20 inches in length, such as, e.g., between approximately 10 inches and approximately 16 inches in length. In some examples, elastic cord 18 may have a length of approximately 12 inches. In some examples, elastic cord 18 may have a diameter between approximately 0.125 inches and approximately 0.625 inches. In some examples, elastic cord 18 may have a diameter of approximately 0.375 inches. Other materials, lengths, and diameters for elastic cord 18 are also contemplated.

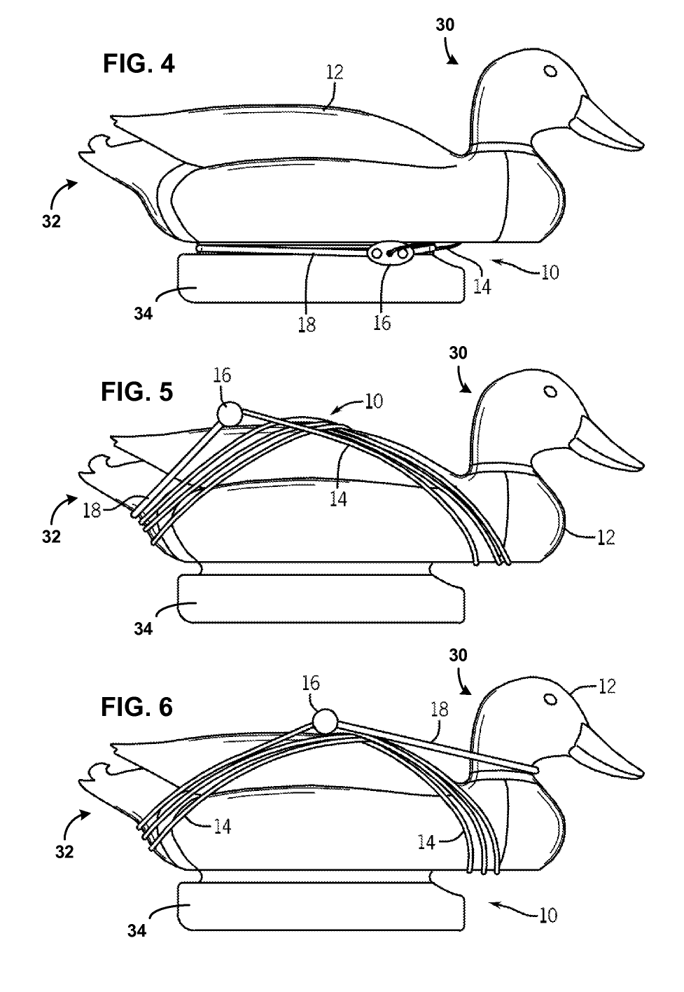

FIGS. 4-6 are conceptual diagrams illustrating various examples of waterfowl decoy system 10 of FIG. 1 in a wrapped and secure configuration. In particular, in each case, substantially the entire length of tether 14 is wrapped about a portion of decoy 12 and loop 19 formed via elastic cord 18 is engaged with a portion of decoy 12 such that the tension of loop 19 prevents tether 14 from becoming unwrapped. For example, in FIG. 4, substantially the entire length of tether 14 is wrapped about keel 34 of decoy 12, and loop 19 of elastic cord 18 is looped about keel 34 to prevent tether 14 from becoming unwrapped. In FIG. 5, substantially the entire length of tether 14 is wrapped in a “figure-eight” configuration about head 30 and tail 32 of decoy 12. Loop 19 is looped over tail 32 of decoy 12 to secure tether 14 in the wrapped configuration. In FIG. 6, substantially the entire length of tether 14 is wrapped in a “figure-eight” configuration about head 30 and tail 32 of decoy 12. Unlike that of FIG. 5, loop 19 is looped over head 30 of decoy 12 to secure tether 14 in the wrapped configuration. FIGS. 4-6 are merely examples of configurations that may be used with decoy weight assembly 17, and other configurations in which tether 14 is wrapped around decoy 12 and loop 19 is looped around a portion of decoy 12 to secure tether 14 are contemplated.

Any suitable technique may be used to assemble waterfowl decoy weight assembly 10 by attaching first and second portion of elastic cord 18 to weight 16 to form loop 19. In one example, a first end portion and a second end portion of elastic cord 18 may be attached to weight 16 to form a loop, such as, loop 19. As described above, in some examples, respective portions of elastic cord 18 may be inserted into one or more apertures in weight 16 and then tied, knotted, and/or crimped to securely form loop 19 coupled to weight 16.

In one example, an assembly technique may include the following. First, molten lead may be poured into a mold having a desired shape. In some examples, the mold may be formed of clay, sand, plaster, or computer numerical controls out of some type of metal (e.g., steel or aluminum). Once the lead has cooled and solidified, the lead weight may be removed from the mold. In cases in which the lead weight has the example shape shown in FIGS. 2 and 3, for example, the ends of an elastic cord that has been cut to length (e.g., approximately 12 inches or approximately 14 inches) may be pulled through respective apertures formed in the lead weight. Each end of the weight may be folded over itself and then crimped together via a metal crimp to secure the fold. In this manner, the elastic cord may form a loop, and the crimped end to prevent the elastic cord from being pulled back through the apertures in the lead weight. Other manufacture techniques are contemplated and may vary based on the particular configuration of the weight and other components.

Examples of the disclosure may provide for one or more advantages. For example, in some examples, an example waterfowl decoy weight assembly may reduce the hassle for a user of a waterfowl decoy by allowing the user to use the elastic cord loop to wrap around the head, tail, keel or other portion of the decoy to secure a tether wrapped about the decoy. As described above, in some examples, when the user wraps the elastic cord around one of these parts of the decoy, tension is created on the elastic cord and, in turn, keeps the wrapped tether from coming loose during transport, thereby eliminating knots, tangles, and the hassles that come with transporting a large number of decoys in a bag.

Various embodiments of the disclosure have been described. These and other embodiments are within the scope of the following claims.

1. A waterfowl decoy weight assembly comprising:
a weight including a tether attachment structure configured to attach to a tether of a floatable waterfowl decoy; and
an elastic cord including first and second end portions, wherein the first and second end portions are attached to the weight at one or more locations to form a loop.

2. The assembly of claim 1, wherein the one or more locations are defined by a first and second aperture extending through the weight, wherein the first end portion extends through the first aperture and the second end portion extends through the second aperture.

3. The assembly of claim 2, wherein the first end portion is knotted to secure the first end portion within the first aperture and the second end portion is knotted to secure the second end portion within the second aperture.

4. The assembly of claim 2, further comprising a first crimp that secures the first end portion in a folded configuration to secure the first end portion within the first aperture, and a second crimp that secures the second end portion in a folded configuration to secure the second end portion within the second aperture.

5. The assembly of claim 1, wherein the tether attachment structure comprises an aperture extending through the weight to allow a tether to be tied to the weight.

6. The assembly of claim 1, wherein the tether attachment structure comprises a peg protruding from a surface of the weight, wherein the peg is configured to allow a tether to be tied to the weight.

7. The assembly of claim 1, wherein the elastic cord comprises a bungee cord.

8. The assembly of claim 1, further comprising a floatable waterfowl decoy.

9. The assembly of claim 1, wherein the weight has a mass between approximately 3 ounces and approximately 8 ounces.

10. The assembly of claim 1, wherein the weight comprises a lead weight.

11. A waterfowl decoy system comprising:
a floatable waterfowl decoy;
a tether; and
a decoy weight assembly, wherein the decoy weight assembly comprises:
a weight; and
an elastic cord including first and second end portions, wherein the first and second end portions are attached to the weight at one or more locations to form a loop,
wherein the tether is coupled to the floatable waterfowl decoy and is coupled the weight.

12. The system of claim 1, wherein the one or more locations are defined by a first and second aperture extending through the weight, wherein the first end portion extends through the first aperture and the second end portion extends through the second aperture.

13. The system of claim 12, wherein the first end portion is knotted to secure the first end portion within the first aperture and the second end portion is knotted to secure the second end portion within the second aperture.

14. The system of claim 12, further comprising a first crimp that secures the first end portion in a folded configuration to secure the first end portion within the first aperture, and a second crimp that secures the second end portion in a folded configuration to secure the second end portion within the second aperture.

15. The system of claim 11, wherein the weight comprises an aperture extending through the weight to allow the tether to be tied to the weight.

16. The system of claim 11, wherein the weight comprises a peg protruding from a surface of the weight, wherein the peg is configured to allow a tether to be tied to the weight.

17. The system of claim 11, wherein the elastic cord comprises a bungee cord.

18. The system of claim 11, wherein the tether is configured to be wrapped around the waterfowl decoy via one or more of a head, tail, and keel of the waterfowl decoy.

19. The system of claim 11, wherein the weight has a mass between approximately 3 ounces and approximately 8 ounces.

20. A method of making a waterfowl decoy weight assembly, the method comprising attaching first and second end portions of an elastic cord to a weight to form a loop, wherein the weight includes a tether attachment structure configured to attach to a tether of a floatable waterfowl decoy.
